(19) United States
(12) Patent Application Publication
(10) Pub. No.: US 2021/0384745 A1
(43) Pub. Date: Dec. 9, 2021

(54) Wall-mounted Wireless Charger with Storage Function

(71) Applicant: Xiaofeng Wang, Shenzhen (CN)

(72) Inventor: Xiaofeng Wang, Shenzhen (CN)

(21) Appl. No.: 17/407,136

(22) Filed: Aug. 19, 2021

(51) Int. Cl. H02J 7/00

(52) U.S. Cl. CPC H02J 7/0044; H02J 50/10

(57) ABSTRACT

A wall-mounted wireless charger with a storage function comprises a fixing panel of an American standard size mounted on a socket and a storage box detachably connected to the fixing panel, wherein the storage box is provided with a storage groove, a notch is formed in a front side of the storage box, an elongated hole communicated with the notch is formed in a bottom of the storage box, and a wireless charging module is disposed in the storage box, located on a side wall of the storage groove, and electrically connected to the socket by means of a wire. Mobile phones, cards, and other supplies may be placed in the storage box, the mobile phones may be hung, on a wall to be charged in the storage box in a wired or wireless manner, so the wireless charger has multiple practical functions.

### BACKGROUND OF THE INVENTION

### 1. Technical Field

The invention relates to the technical field of sockets, in particular to a wall-mounted wireless charger with a storage function.

### 2. Description of Related Art

As is commonly known, wireless chargers are charging devices based on the electromagnetic induction principle. Similar to the principle of transformers, a transmitting terminal and a receiving terminal are each provided with a coil, the coil at the transmitting terminal sends an electromagnetic signal to the outside under the effect of power, and the coil at the receiving terminal receives the electromagnetic signal and converts the electromagnetic signal into current to fulfill wireless charging. The wireless charging technique, as a special power supply method, fulfills wireless charging by converting the energy of propagated electromagnetic waves into electric energy without power lines, thus being convenient to use and having been widely applied.

However, existing wireless chargers only have a charging function. In modern society where nearly everyone possesses a mobile phone, mobile phone charging is especially important for users. Existing sockets are typically integrated with a USB female plug and a Type-C female plug or a power jack, and a charging cable is plugged into the USB female plug and/or the Type-C female plug and/or the power jack to charge mobile phones. The sockets are provided with a fixing panel. In most cases, customers plug a charging plug, into the socket, then connect a charging cable to a mobile phone, and then place the mobile phone on a desk for wireless charging; or the customers place a wireless charger on the desk and then place the mobile phone on the wireless charger for charging. However, when one socket is shared by multiple mobile phones or household appliances, multiple wires and wireless chargers have to be placed on the desk and occupy too much space of the desk, which makes the desk in a mess; moreover, in some cases where the mobile phones are touched by children or water in cups is spilled onto the desk, the mobile phones will not be able to be charged stably; and if users forget to carry a charging cable, the mobile phones will not be able to be charged either. So, all existing charging methods cannot realize charging easily.

### BRIEF SUMMARY OF THE INVENTION

To overcome the defects of the prior art, the objective of the invention is to provide a wall-mounted wireless charger with a storage function.

To fulfill the above objective, the invention adopts the following technical solution:

A wall-mounted wireless charger with a storage function comprises a fixing panel of an American standard size mounted on a socket and a storage box detachably connected to the fixing panel, wherein the storage box is provided with a storage groove, a notch is formed in a front side of the storage box, an elongated hole communicated with the notch is formed in a bottom of the storage box, slots allowing wires to be clamped, therein are formed in top ends of left and right sides of the storage box, and a wireless charging module is disposed in the storage box, located on a side wall of the storage groove, and electrically connected to the socket by means of a wire.

Preferably, non-through dovetail grooves are formed in left and right sides of the fixing panel, and trapezoidal rails matched with the dovetail grooves are formed in the left and right sides of the storage box and are selectively inserted, into the dovetail grooves.

Preferably, a C-shaped clamping hole communicated with two ends of the elongated hole is formed in the bottom of the storage box, and a width of an opening of the clamping hole is smaller than that of the elongated hole.

Preferably, the wireless charging module is provided with a USB input interface exposed out of a bottom surface of the storage box, and the USB input interface is electrically connected to the socket by means of a wire.

Preferably, a wireless charging symbol is disposed on the storage box and is located on the side wall of the storage groove.

Preferably, a C-shaped elastic element is disposed on an inner wall of the storage groove and protrudes by a height of 1-10 MM.

By adoption of the above solution, the invention has the following beneficial effects:

1. The wireless charging module is disposed in the storage groove of the storage box, so that mobile phones, cards, and other supplies can be stored in the storage box, and the mobile phones can be hung on a wall to be wirelessly charged in the storage box; or, the mobile phones arc directly hung in the storage box and are then charged in a wired manner by means of a charging cable, such that the mobile phones can be charged easily; in addition, the mobile phones are hung on the wall and do not occupy the space of a desk, so that the desk is tidier, and the mobile phones can be safely and stably charged in the storage box with low external interference;

2. The trapezoidal rails on the left and right sides of the storage box may be inserted into the dovetail grooves in the left and right sides of the fixing panel, so that the storage box may be selectively and flexibly mounted on the left side or the right side of the fixing panel during decoration; and the storage box may be mounted on the wall corresponding to the fixing panel without adhesives or nails, so that nail-free installation of the storage box is realized, and the storage box can be mounted easily;

3. The slots and the notch are formed in the storage box, so that power lines of household appliances can penetrate through the notch to be clamped in the slots to be fixed; the clamping hole corresponding to the elongated hole is formed in the storage box, so that power lines of household appliances can be clamped in the clamping hole, and thus, the wireless charger has multiple practical functions, fully meets the actual usage requirements of users, effectively improves the user experience, and is simple in structure, easy to operate, and high in practicability.

### BRIEF DESCRIPTION OF THE SEVERAL VIEWS OF THE DRAWINGS

FIG. 1 is an axonometric drawing of one embodiment of the invention.

FIG. 2 is an axonometric drawing from another perspective of the embodiment of the invention.

FIG. 3 is a top view of the embodiment of the invention.

In the drawings:

1, fixing panel; 2, storage box; 3, storage groove; 4, notch; 5, elongated hole; 6, slot; 7, wireless charging module; 8, dovetail groove; 9, trapezoidal rail; 10, clamping hole; 11, USB input interface; 12, wireless charging symbol; 13, elastic element.

### DETAILED DESCRIPTION OF THE INVENTION

The embodiments of the invention will be described in detail below in conjunction with the accompanying drawings. Obviously, the invention may be implemented in different manners defined and covered by the claims.

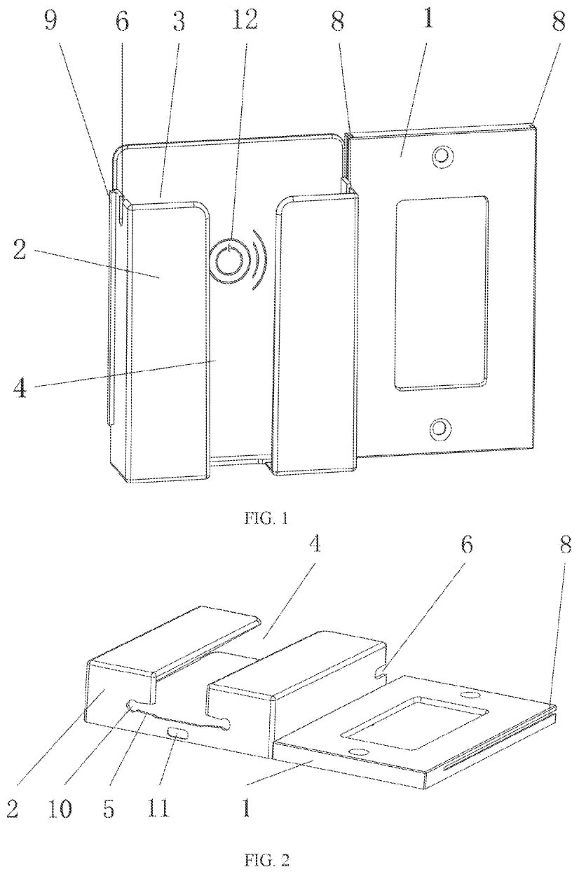

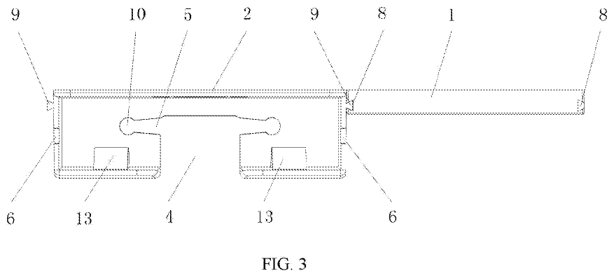

As shown in FIG. 1-FIG. 3, this embodiment provides a wall-mounted wireless charger with a storage function. The wall-mounted wireless charger with a storage function comprises a fixing panel of an American standard size mounted on a socket and a storage box 2 detachably connected to the fixing panel 1, wherein the storage box 2 is provided with a storage groove 3, a notch 4 is formed in a front side of the storage box 2, an elongated hole 5 communicated with the notch 4 is formed in a bottom of the storage box 2. slots 6 allowing wires to be clamped therein are formed in top ends of left and right sides of the storage box 2, and a wireless charging module 7 (not shown) is disposed in the storage box 2, located on a side wall of the storage groove 3, and electrically connected to the socket by means of a wire. Through the configuration of the slots 6 and the notch 4, power lines of household appliances may be clamped in the slots 6 to be fixed.

Furthermore, in this embodiment, non-through dovetail grooves 8 are formed in left and right sides of the fixing panel 1, and trapezoidal rails 9 matched with the dovetail grooves 8 are disposed on the left and right sides of the storage box 2 and are selectively inserted into the dovetail grooves 8. The dovetail grooves 8 and the trapezoidal rails 9 are used cooperatively to guide and support the storage box 2 and the fixing panel 1, such that the storage box 2 and the fixing panel 1 can be connected more stably.

Furthermore, in this embodiment, a C-shaped clamping hole 10 communicated with two ends of the elongated hole 5 is formed in the bottom of the storage box 2, and the width of an opening of the clamping hole 10 is smaller than that of the elongated hole 5. Power lines of household appliances may be clamped in the clamping hole 10.

Furthermore, in this embodiment, the wireless charging module 7 is provided with a USB input interface 11 exposed out of a bottom surface, of the storage box 2, and the USB input interface 11 is electrically connected to the socket by means of a wire.

Furthermore, in this embodiment, a wireless charging symbol 12 is disposed on the storage box 2 and is located on the side wall of the storage groove 3.

Furthermore, in this embodiment, the fixing panel 1 of the American standard size can replace an old panel on an original socket to be fixed on the original socket, so the old panel on the original socket can be mounted and replaced easily.

Furthermore, in this embodiment, C-shaped elastic elements 13 are disposed on an inner wall of the storage groove 3 and protrude by a height of 1-10 MM. Considering that different mobile phones have different thicknesses, the elastic elements 13 are disposed in the storage groove 3 to ensure that mobile phones with different thicknesses may be inserted into the storage groove and be attached to the wireless charging module 7 in the storage groove 3, so that the wireless charging efficiency is higher, and the storage groove 3 is suitable for mobile phones with different thicknesses.

When the wireless charger in this embodiment is used, a mobile phone is placed in the storage groove 3, and a charging cable is plugged into the socket and then penetrates through the elongated hole 5 to be connected to the mobile phone to charge the mobile phone wirelessly. The wireless charging module 7 is disposed in the storage groove 3 of the storage box 2, so that mobile phones, cards, and other supplies can be stored in the storage box 2, and the mobile phones can be hung on a wall to be wirelessly charged in the storage box 2; or, the mobile phones are directly hung in the storage box 2 and are then charged in a wired manner by means of a charging cable, such that the mobile phones can be charged easily; in addition the mobile phones are hung on the wall and do not occupy the space of a desk, so that the desk is tidier, and the mobile phones can be safely and stably charged in the storage box 2 with low external interference; the trapezoidal rails 9 on the left and right sides of the storage box 2 may be inserted into the dovetail grooves 8 in the left and right sides of the fixing panel 1, so that the storage box 2 may be selectively and flexibly mounted on the left side or the right side of the fixing panel 1 during decoration; the storage box 2 may be mounted on the wall corresponding to the fixing panel without adhesives or nails, so that nail-free installation of the storage box is realized, and the storage box 2 can be, mounted easily; besides, the slots 6 and the notch 4 are formed in the storage box 2, so that power lines of household appliances can penetrate through the notch 4 to be clamped in the slots 6 to be fixed; the clamping hole 10 corresponding to the elongated hole 5 is formed in the storage box 2, so that power lines of household appliances can be clamped in the clamping hole 10. So, the wireless charger has multiple practical functions fully meets actual usage requirements of users, and effectively improves the user experience.

Furthermore, in this embodiment, the USB input interface 11 is a LTSB-Type-C connector, a USB-Type-B connector, a DC connector, a Lightning connector, a Micro USB connector, a USB-Type-C plug, a USB-Type-B plug, a DC plug, a Lightning plug, or a Micro USB plug. This embodiment has no specific limitation to the standard of the USB input interface 11.

The above embodiments are merely preferred ones of the invention, and are not intended to limit the scope of the patent of invention. All equivalent structures or equivalent flow transformations made according to the contents in the specifications and drawings of the invention, or direct or indirect applications to other relevant technical fields, should also fall within the protection scope of the patent of invention.

What is claimed is:

1. A wall-mounted wireless charger with a storage function, comprising a fixing panel of an American standard size mounted on a socket and a storage box detachably connected to the fixing panel, wherein the storage box is provided with a storage groove, a notch is formed in a front side of the storage box, an elongated hole communicated with the notch is formed in a bottom of the storage box, slots allowing wires to be clamped therein are formed in top ends of left and right sides of the storage box, and a wireless charging module is disposed in the storage box, located on a side wall of the storage groove, and electrically connected to the socket by means of a wire.

2. The wall-mounted wireless charger with a storage function according to claim 1, wherein non-through dovetail grooves are formed in left and right sides of the fixing panel, and trapezoidal rails matched with the dovetail grooves are disposed on the left and right sides of the storage box and are selectively inserted into the dovetail grooves.

3. The wall-mounted wireless charger with a storage function according to claim 2, wherein a C-shaped clamping hole communicated with two ends of the elongated hole is formed in the bottom of the storage box, and a width of an opening of the clamping hole is smaller than that of the elongated hole.

4. The wall-mounted wireless charger with a storage function according to claim 3, wherein the wireless charging module is provided with a USB input interface exposed out of a bottom surface of the storage box, and the USB input interface is electrically connected to the socket by means of a wire.

4. the wall-mounted wireless charger with a storage function according to claim 4, wherein a wireless charging symbol is disposed on the storage box and is located on the side wall of the storage groove.

6. The wall-mounted wireless charger with a storage function according to claim 4, wherein a C-shaped elastic element is disposed on an inner wall of the storage groove and protrudes by a height of 1-10 MM.
